(19) United States
(12) Patent Application Publication
(10) Pub. No.: US 2002/0022974 A1
(43) Pub. Date: Feb. 21, 2002

(54) Display of patent information

(76) Inventor: Urban Lindh, Jarfalla (SE)

Correspondence Address: BURNS DOANE SWECKER & MATHIS L L P, POST OFFICE BOX 1404, ALEXANDRIA, VA, 22313-1404, US

(21) Appl. No.: 09/834,909

(22) Filed: Apr. 16, 2001

Related U.S. Application Data
(60) Provisional application No. 60/197,771, filed on Apr. 14, 2000.

(51) Int. Cl. G06F 17/60; G06F 17/30

(52) U.S. Cl. 705/3; 707/3; 345/744; 345/866

(57) ABSTRACT

A method for obtaining patent information across a multitude of databases, categorizing the information and displaying the information. The information obtained is stored and linked to the individual patent to which it originated or is directed towards. The information is categorized according to the desires of the user. The information is displayed, usually in a statistical format, to aid in the determination of the validity and strength of the patent or a group of patents, patent portfolio.

### FIELD OF INVENTION

This invention is directed towards displaying information about patents in a manner that is easily interpreted, thereby enabling a user to determine the value of a patent or possible future patent.

### DESCRIPTION OF RELATED ART

The value of a patent or a group of patents, or patent portfolio, is often difficult to discern. Many factors are involved in making this determination such as, the marketable value or the strength of the patent with respect to other patents of similar technology. Obtaining a patent affords the owner of the patent several rights and to utilize these rights effectively it may be necessary to know the value or strength of the patent or patents owned. The owner of the patent, or others who may be interested in the patent, may need to ascertain the value or strength of the patent or patent portfolio for such reasons as determining licensing fees, the value of a company's portfolio, where most of the research lies and how that relates to the open market, or what the strength of the patent might be if litigated against, etc.

Currently, there are few means by which someone could make a determination of the value or strength of individual or groups of patents. There are several resources and databases that contain information on each patent that is published in every country. However, even with the vast information available in the databases, only the information pertaining to each individual patent can be viewed. Therefore, there is a need to provide those wishing to evaluate the validity and strength of their patent portfolios, with various information concerning patents in a manner that is easily viewed and understood.

Accordingly, it is an object of the present invention to provide means for easily obtaining, categorizing and visualizing information on a group of patents or patent portfolio to aid in the determination of the validity of those patents

### SUMMARY OF THE INVENTION

In pursuit of these objectives, the present invention provides means for displaying the contents of a patent and more specifically the classification of one or more patents, viewed in a statistical format for easier interpretation of the data. The present invention also provides means for obtaining and statistically displaying cited references and patents that correlate to each group or subgroup of classified patents.

The patent data acquired is retrieved from several databases that contain the individual patents and their corresponding information. Many databases contain only a small part of the desired patent information. Also, many databases store the information in different formats. Therefore, the present invention also provides means for obtaining data on individual patents from several databases and linking together any information pertaining to the individual patent.

After the data has been obtained, it can be categorized in the way the user desires. This enables the user the capability to view the data that is most relevant to the user. The data is then displayed in a statistical manner providing the user with a detailed view of all patent information that the user selects to view, aiding the user in determining the strength and validity of the patent or patent portfolio.

### BRIEF DESCRIPTION OF THE DRAWINGS

Various exemplary embodiments of this invention will be described in detail, with references to the following figures, wherein:

FIG. 1 is a block diagram of the main components of an exemplary computer system;

FIG. 2 is an exemplary screen display illustrating the import features and functions;

FIG. 3 is a flowchart outlining the preparation before the importation of data;

FIG. 4 is a flowchart detailing the steps for importing data from various databases;

FIG. 5 is a flowchart detailing the steps for importing data that contains citation data;

FIG. 6 is an exemplary screen display, that illustrates the report of the data that corresponds to the imported data; and

FIG. 7 is an exemplary screen display illustrating the citation statistics of the reported data.

### DETAILED DESCRIPTION OF PREFERRED EMBODIMENTS

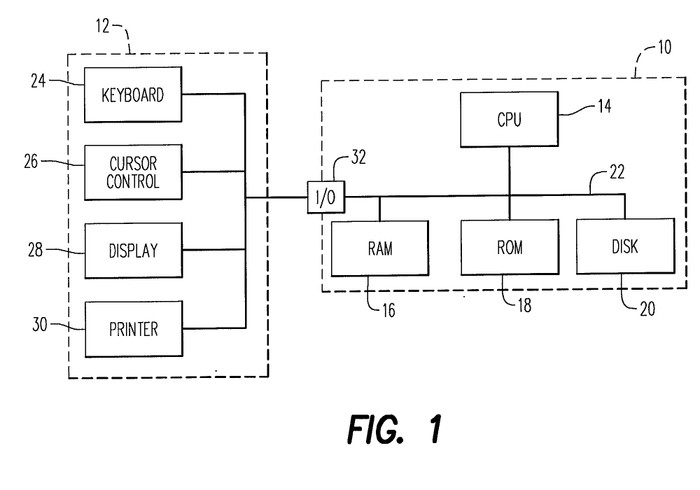

FIG. 1 illustrates a block diagram of a typical computer system in which the present invention can be implemented. The structure of the computer itself does not form part of the present invention. It is briefly described here for subsequent understanding of the manner in which the features of the invention cooperate with the structure of the computer. It should be noted that any computer system that is capable of implementing the concepts of the present invention, can be used to employ those concepts.

Referring to FIG. 1, the system includes a computer 10 having a variety of external peripheral devices 12 connected thereto. The computer 10 includes a central processing unit (CPU) 14, a main memory which is typically implemented in the form of a random access memory 16, a static memory that can comprise a read only memory 18, and a permanent storage device, such as a magnetic or optical disk 20. The CPU 14 communicates with each of these forms of memory through an internal bus 22. The peripheral devices 12 include a data entry device such as a keyboard 24, and a pointing or cursor control device 26, such as a mouse, trackball or the like. A display device 28, such as a CRT monitor or an LCD screen, provides a visual display of the information that is being processed within the computer, for example the contents of a document. A hard copy of this information can be provided through a printer 30, or similar such devices. Each of these external peripheral devices communicates with the CPU 14 by means of one or more input/output ports 32 on the computer.

The present invention is directed towards the acquiring of data, corresponding to patents, across various databases and the display of that data in a manner that aids in determining the strength or value of the patent or a group of patents, as related to other patents. To accomplish these tasks, patent data is acquired from various bibliographical databases. Database host such as Dialog and STN contain vast amounts of data on patents worldwide, however, any bibliographical database that contains the patent information can be used to acquire the patent data. The data acquired is then stored in internal databases. The data retrieved for each patent record or file, i.e. assignee, abstract, title, etc., are linked to each other by what is referred as “tight links” and “loose links”. A tight link is when information is directly linked to the patent record by the access number or patent number of the patent. Therefore, any data retrieved pertaining to a patent is stored under the access number or patent number representative of that patent and is hence directly linked or “tight linked” to that patent record. A loose link is when information that does not contain an access number or patent number or may not be directly related to one particular patent but several patents, such as group of patents assigned to a company or related to a specific technical art, is linked to those patents or group of patents by other parameters, such as the company name, inventor etc. Once the loose links have been linked to the patent or patent groups, the user can determine if the information is pertinent to a particular patent record and tight link them to that specific patent record. This flexibility makes it possible to retrieve data from the various databases and relate it to the patent record to which it corresponds.

After the patent data has been imported and stored, the user has a variety of choices for displaying the data. Once the data is displayed, the user can then interpret the data to assess the validity and value of the patent, as compared to other patents and data obtained for those other patents.

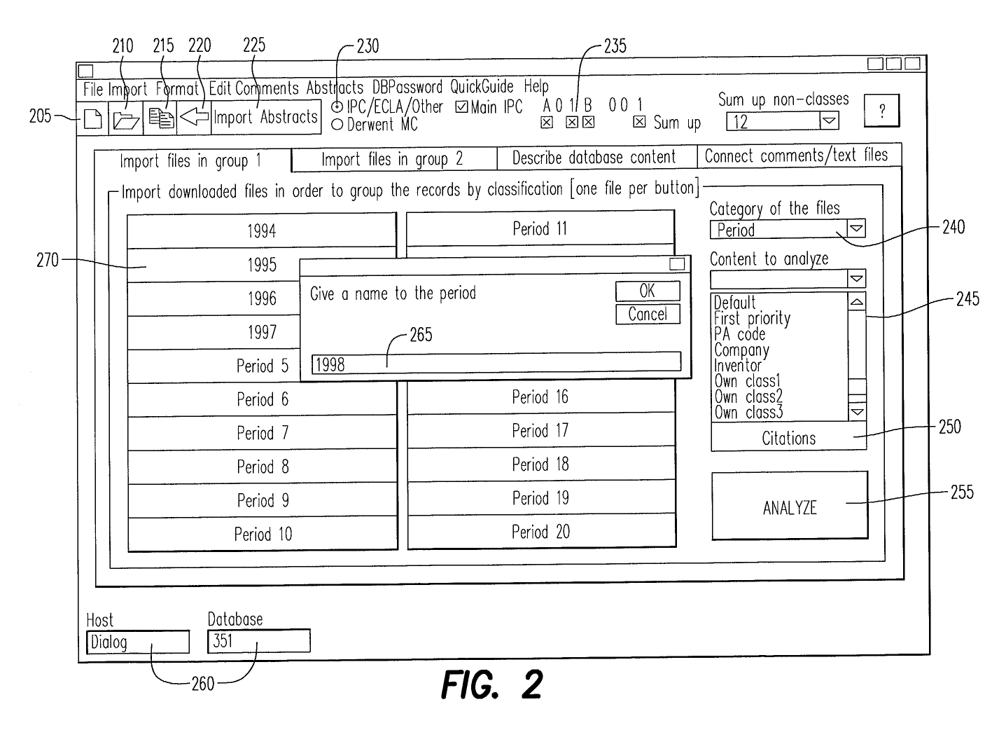

An exemplary screen display is shown in FIG. 2. This screen display shows the features available for importing the data and how the data is to be grouped when displayed. Many features are available in the pull down menus, however, some widely used features may be represented by buttons and boxes displayed on the screen. For example, the button 205, when clicked, will prompt the user for a name in which a new internal database is created. This newly created database can contain any amount of patent information that is imported. Buttons, 210, 215 and 220 when clicked, provide various functions. Button 210 opens existing internal databases, button 215 makes a copy of any internal database and button 220 returns to a previous screen.

The present application can support several types of files. These include files with the extensions, .STA, .AB, .HTM, .MPT and .ABS. These extensions are standard extensions used to identify the type of data the file contains. However, any file with an extension different from the above, that contains bibliographic information, can be adapted to be supported by the operations of the present invention.

The .MPT and .ABS are extension used to distinguish those files as databases. The .MPT and .ABS databases are internal databases created to store imported files with the extension .STA and .AB. The .STA files are ordinary text files which are downloaded from a database host. The .AB files contain the bibliographical records, such as the abstracts of the .STA files.

When bibliographical records are imported, button 225, if selected, provides a quick way to create an internal database that contains those bibliographical records. Therefore, when a user, utilizing the features of the present invention, views a title of a patent or reference that may be of interest, the abstract can be viewed to gain a better understanding of the contents of the patent or reference. Button 230 provides a quick way for a user to choose how they would like the imported data to be grouped. The data can be grouped by classification, Derwent classification code or other classifications. However, the grouping of the data is not limited to the above groupings, but can be any classification or categorical groupings determined by the user. The check boxes 235, when checked will sum up the records, contained in the imported data, to the third, fourth or eighth character level.

The category button 240 allows the user to categorize the imported data records. For example, the data records of screen display 200 are categorized by the year the patent or reference was published. In the example shown in FIG. 2, there are four categories 270 ranging from 1994 to 1997. However, the categories can be changed to any category that fits the need of the user, such as a company name, country or type of patent or reference (i.e., business or technology). To change the name the user clicks on the box and the user is prompted for a new name 265.

A key feature of the present invention is its versatility in how data is retrieved, categorized and displayed. For example, data can be retrieved from a patent database, technology database, and/or a business database. The data retrieved from theses databases can be categorized in three categories pertaining to each database. The information retrieved, from each database, can be viewed and compared with each other on the same screen. Thus, in this example, the number of records per company can be displayed having access to underlying documents in each of the above categories. This may aid in determining what Research and Development groups have the most patents and how that relates to their business activities, etc.

Another feature of the present invention is the ability to view the number of cited references and patents that are attached to a patent or group of patents. The citation button 250 allows a user to import data from the Derwent Patent Citation Index. The citation information is used in aspects of the present invention, which will be described later, to show how many patents or references are cited for a group or individual patent. The data corresponding to these cited references and patents can then be used to provide more information on their content. The data in box 245 allows the user to choose other choices for classification of the data, rather than just a default classification.

The data contained in the boxes 260 at the bottom of the screen display provide information about the data records in each category. These boxes may provide information such as, where the data is obtained, how many titles were imported and how many duplicates there are of the same data record.

When the data is obtained and the internal databases are created, the data can then be analyzed. The analyze button 255, when selected, provides the data in the manner that was requested by the user, basically how the data is displayed.

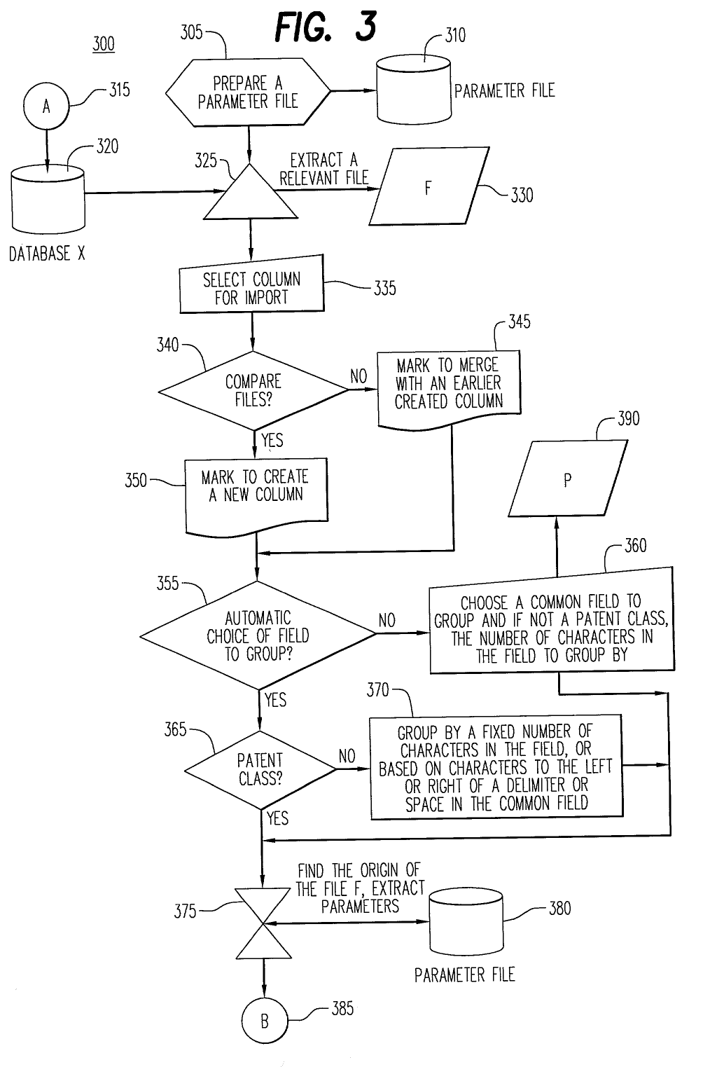

Since the data represents records of patents and because different parts of the data may come from different databases, it is necessary to link together all the different data that corresponds to an individual patent. FIG. 3 is a flow chart outlining the preparation that takes place before data can be imported. During this preparation a parameter file is created 305 and stored in a storage medium 310. The parameter file is based on the bibliographical information of the data obtained. This usually includes the title, access number and/or classification code. However, any bibliographical information can be used in the parameter file. When comparing files from different databases in different columns any bibliographic information can be used that is universal across the different databases. Based on the parameter file created, data is then extracted from the database and imported.

Starting at A 315, control continues to 325 where the user connects to a database 320. In 305, a parameter file is prepared and stored in 310. In 335, it is determined what column the data is going to be imported into. This can be any column that is selected by the user. In step 340, a determination is made whether the imported data is going to be compared with each other or merged together. If the data is to be merged with other imported data, then the data is marked 345 to merge with an earlier imported column of data. If the data is going to be compared with other columns of data, then the data is marked to create a new column 350 for the data. It is determined whether or not the field to group the data is automatically chosen 355. If the field is not automatically chosen, then in step 360 the common field to group the data is chosen in accordance with the data from the parameters 390. If the field is automatically chosen, then in step 365 it is determined whether to group by patent class or not. If the data is not grouped by a patent class, then in step 370, the data is grouped by a fixed number of characters in the field, or based on characters to the left or right of a delimiter or space in the common field. If the decision is made to group on the patent class, then in 375, the origin of the file is found and the parameters extracted. Control then proceeds to step B 385.

To group by a fixed number of characters, the user basically chooses the length of characters to which the use wants the data grouped. For example, if the user is going to group by company names, and in a file in which the user is importing there is a company named Micro. In the file you find other companies named Micro Europe, Micro Japan and Micro Inc. If the user groups by 5 characters then all these companies will be grouped under Micro. If the user chooses 7 characters or more in which to group, the companies will belong to different groups.

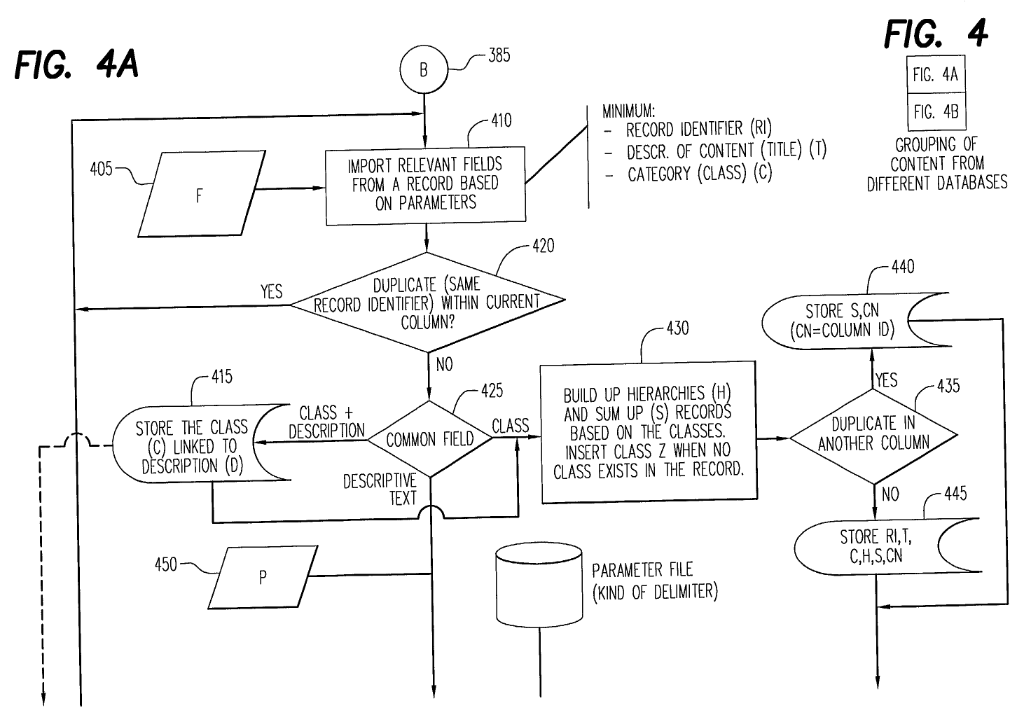

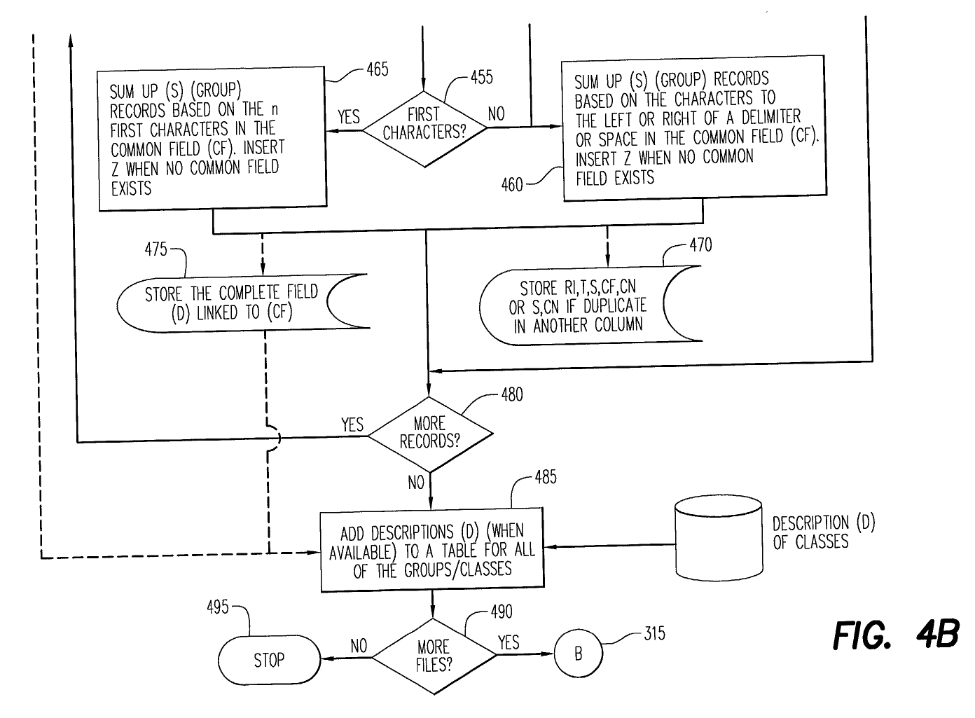

FIG. 4 is a flowchart that outlines the grouping of content from the different databases. The relevant fields contained in a record, based on the parameters of FIG. 3, are imported 410 from the patent file 405. In step 420, it's determined whether or not the patent record has already been imported. This is accomplished by comparing the record identifier i.e. access number, with those already obtained. If the patent record has already been acquired within the current column, then control returns to step 410 and a different patent record is imported. If the patent record has not already been imported, meaning a duplicate is not found, then in step 425, the patent record is grouped based on a common field.

In step 430, hierarchies of the patent classes within the current patent are built up and all the patent records are summed based on the patent class in which they are located. If no class exists, then class Z is inserted to represent that no class exists in the record. In step 435, it is determined if the data is duplicated in another column. If the data is already present in another column, then in step 440 the column I.D. and sum is stored. If a duplicate is not found then in step 445, the record identifier i.e. access number, patent number etc., title, category, class, hierarchy, sum and column I.D. of the patent record are stored within an internal database of the present invention. In step 415, the class and description are stored. This data is linked to steps 430 and 485. In those steps data can be retrieved from step 415.

The parameters are contained in file 450. In step 455, it is determined whether ro sum up the groups based on the first characters. If the groups are summed based on the first characters, then in step 465, the groups are summed based on the number of characters selected by the user in the common field. If no common field exists a Z is inserted. If the data is not grouped based on the first characters, then the grouping is based upon the characters 460 to the left or to the right of a delimiter or space in the common field. A Z is inserted when no common field exists. After steps 460 and 465, the data is stored in steps 470 and 475.

In step 480, a determination is made whether or not more patent records are to be obtained. If more records are to be obtained, then control returns to step 410. If all records have been obtained, then in step 485 descriptions are added to the built up groups/hierarchies and the individual classes or fields to which the records belong. In step 490, it is determined whether more files from the external databases are needed. If more patent files are needed, then control returns to step 315 of FIG. 3. If no more patent files are needed, then in step 495, the routine stops.

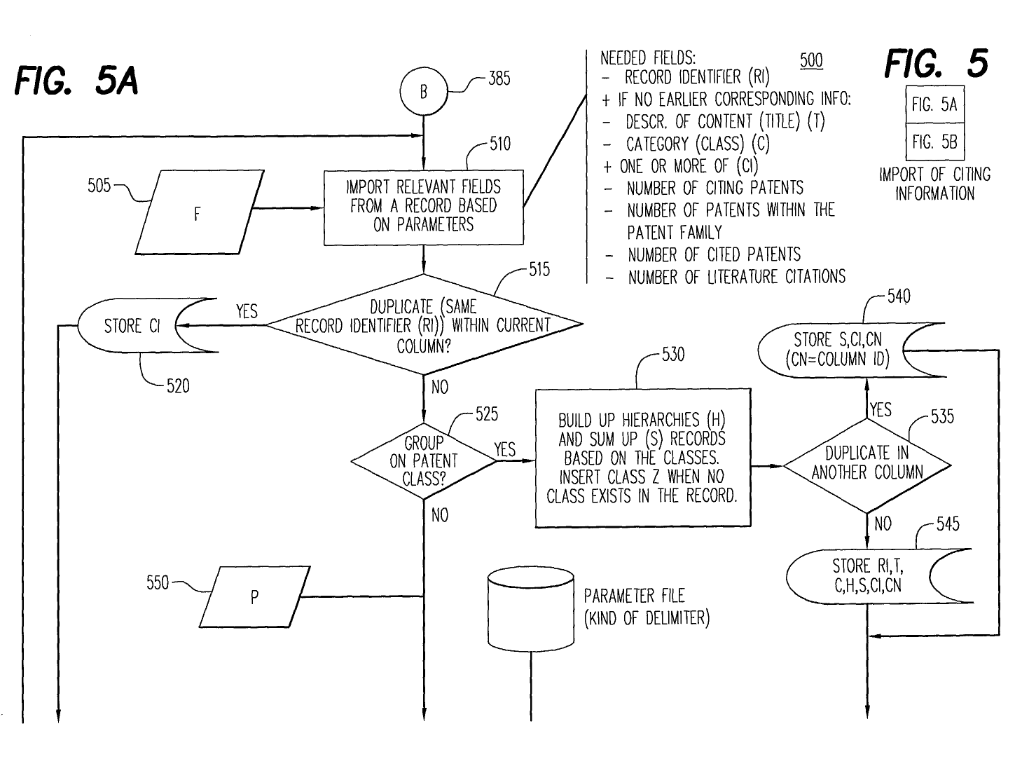

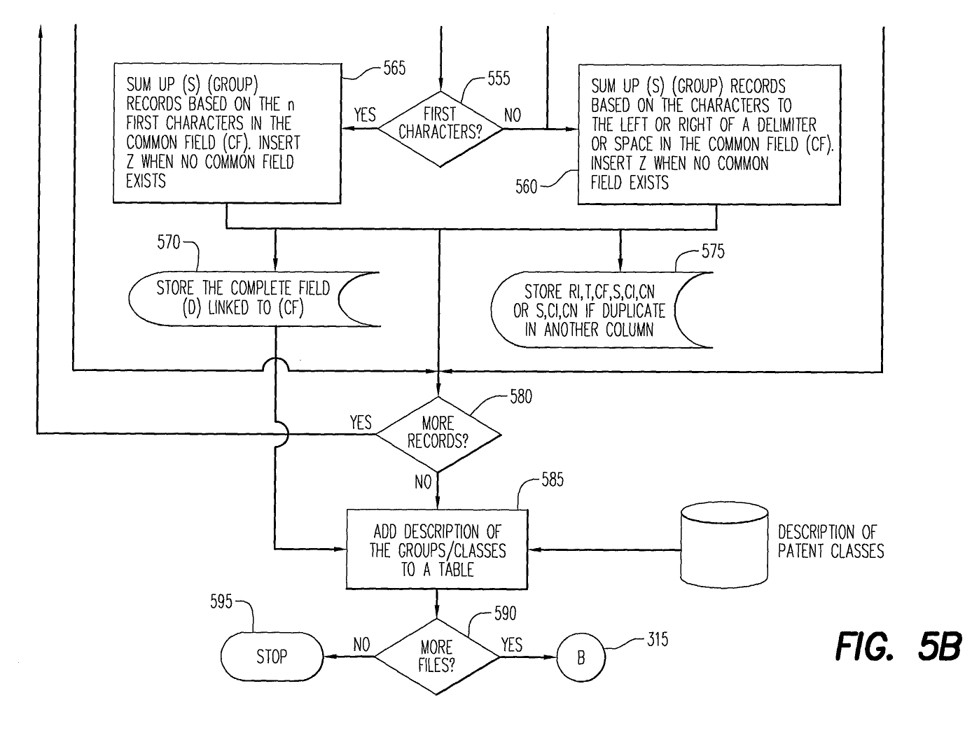

FIG. 5 is a flowchart that outlines the steps for acquiring citation information on the patent records obtained. The citation information are the patents and articles, that were cited as references in the prosecution of the patent. The steps for acquiring citation information is similar to the steps used to acquire the patent records of FIG. 4. The citation information is usually acquired from databases such as the Derwent Patent Citation Index, however any database that contains citation information may be used to acquire the citation information.

In step 510 relevant fields from a patent record, including citation information, based on the parameters of the patent file 505 are imported. In step 515, it is determined if the record has already been obtained. If the record has already been obtained then, in step 520, the citation information is stored and then control continues to step 575. If the record has not been obtained, then it is decided, in step 525, whether to group the record on the patent class it belongs to or not. If the record is grouped on the patent class, then in step 530 hierarchies of the patent classes within the current patent are built up and the records in each patent class are summed, to give a total of all records obtained that belong in that class. In step 535, it is determined if the data is duplicated in another column. If the data is already present in another column, then in step 540 the column ID, citation information and summed number is stored. If a duplicate is not found then in step 545, the record identifier i.e. access number, patent number etc., title, category, class, column I.D. and citation information of the patent record are stored within an internal database of the present invention

If the patent record is not grouped by the patent class, then in step 555, it is determined whether to sum up the groups based on the first characters. If the groups are summed based on the first characters, then in step 565, the groups are summed based on the number of characters selected by the user in the common field. If no common field exists a Z is inserted. If the data is not grouped based on the first characters, then the grouping is based upon the characters 560 to the left or to the right of a delimiter or space in the common field. A Z is inserted when no common field exists. After steps 560 and 565, the data is stored in steps 570 and 575.

In step 580, it is determined whether citation information needs to be obtained for more patent records. If more citation information does need to be obtained, then the control returns to step 510. If all citation information has been obtained, then in step 585 the description of the groups are added to a table that contains all the summed data. In step 590, a determination is made whether or not more patent files are needed. If more patent files are needed, then control returns to step 315 of FIG. 3. If no more patent files are needed, then the routine continues to step 595 and stops.

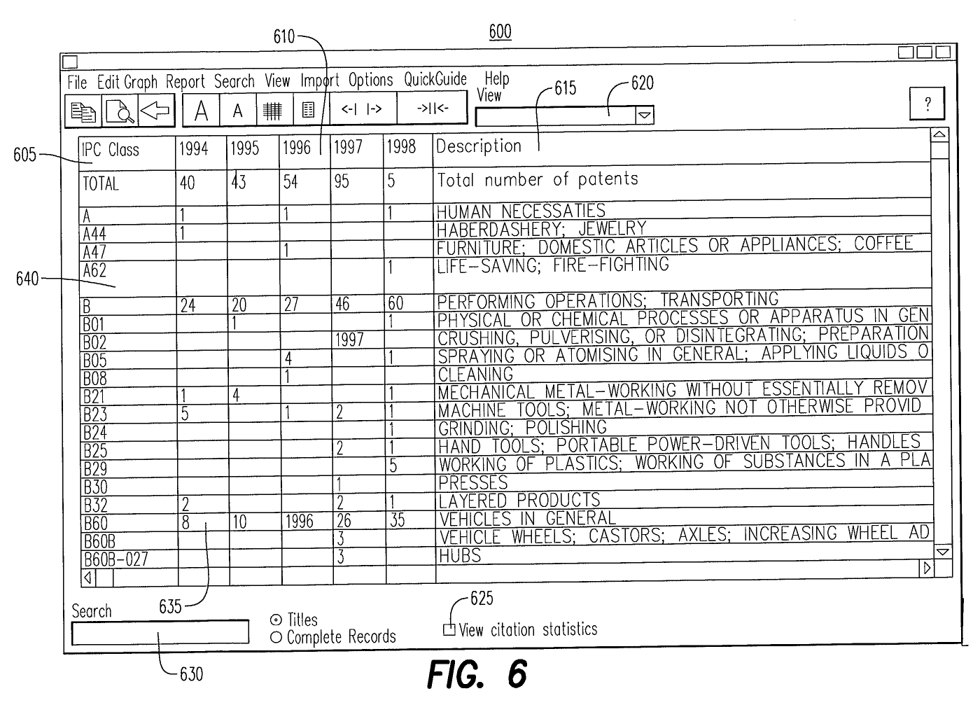

Once the patent data has been imported and the data configured to the users desires, the data can be displayed and viewed in a statistical format. This gives the user an overall view of the patents that were imported and how they relate to each other. FIG. 6 is an exemplary screen display showing a statistical view of the imported patent data, set up in the manner as described in FIG. 2. In this example, the data is categorized according to the year in which the patent was published 610 and the international patent classification (IPC) 605. The total number of patents pertaining to each year is located on the second row. In the first column, starting on the third row, are the IPC classifications 640. On each row adjacent to the IPC classifications, under each year, are the number of patents 635 in that classification for that particular year. For example, in the sixth row under the classification B, there are 24 patents classified under B in 1994, 20 in 1995, 27 in 1996, 46 in 1997 and 60 in 1998.

In the sixth column are the descriptions of the classifications 615. These descriptions provide the user with an understanding of the technology and subject in which the patents in that row correspond. Using the example above, the description states that the patents under the B classification are generally related to performing operations and/or transporting.

To view the individual patents in any particular row or column, the user simply selects that column and row by clicking on it with a mouse or similar device. The titles corresponding to the row and column selected will appear. As the user is viewing the titles, they can select or have the titles thrown. Therefore, as they view the titles the patents of interest can be selected and those titles will move in another section for selected titles. Also, the patents that aren't desired for whatever reason may be selected and moved to another section for thrown titles. This gives the user a clear view of what is selected and what isn't, this information will be stored and used when further selections are made.

The view pull down menu 620 allows the user to view other data corresponding to the selected and thrown titles. When selected the menu 620 provides several options, these include displaying the selected titles, the access numbers or reduced access numbers, the thrown titles, displaying the selected bibliographical records or all bibliographical records. When the access number option is used, the access numbers corresponding to the selected titles are listed in different formats that can be used to obtain the entire patent in various databases. The reduced access number only provides the access numbers for selected titles that do not have corresponding bibliographical records. If the user chooses to display the bibliographical records, the bibliographical records for the selected titles are displayed in a separate section. Comments concerning the abstract can be added in a comments section. The bibliographical records can also be marked for priority. Another feature that is provided is the ability to classify the bibliographical records under classifications that the user selects, thus providing the user with the freedom to manipulate the data and view it according to their needs. The bibliographical records can be exported either all of them or based on information entered by the user. The records can be imported into current or a new internal database, where the user defined classes can be used to group the information and thus create a new view of the information.

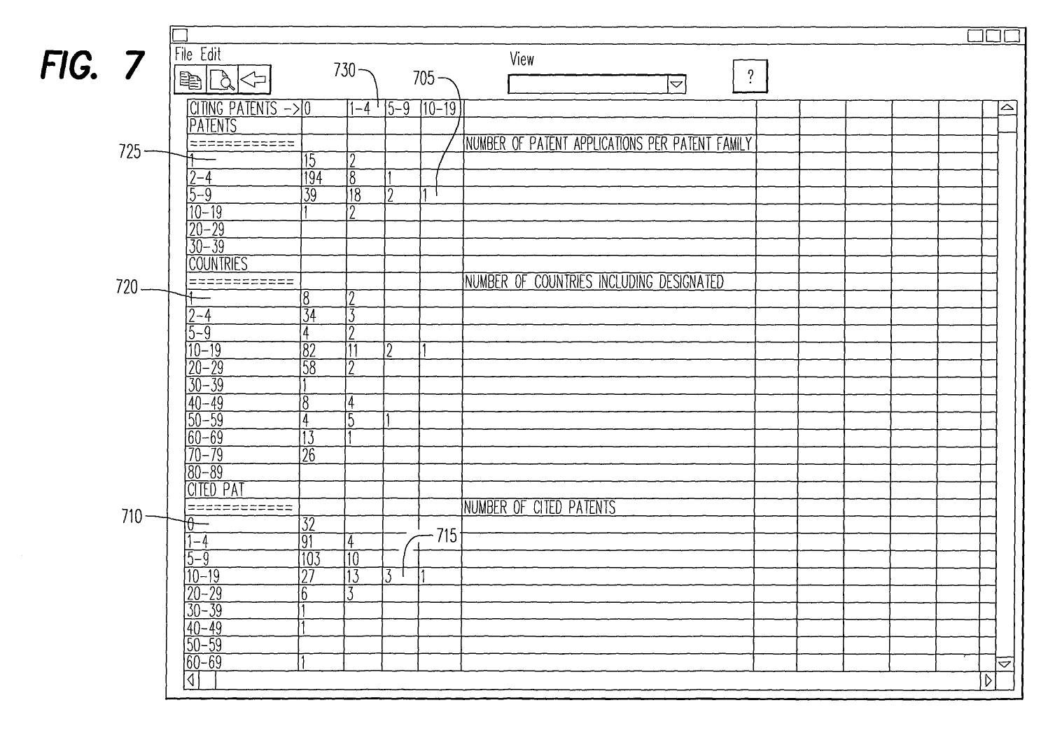

Another feature shown in FIG. 6 is the ability to search the patents for a particular word 635 in combination with any group. Also, a view citation statistic box is provided 625. When selected the user can click on any column and row coordinate, that contains a number representative of patents and view the citation information for that group of patents in a statistical format, as shown in FIG. 7.

A good way to view the value of a patent or a group of patents is to look at the number of citing patents/patent applications that are referenced to those patents or group of patents, as this may indicate that many others are interested in the same technology. A large number of citing patents does not always mean that the cited patent is highly valuable. However, by combining this information with other parameters the user can be given a multitude of information to draw their conclusions of the strength and/or validity of the patent or patent group. Other parameters may include information from the Derwent Patent Citation Index, the number patents/patent applications within the patent family and/or the number of countries that patents are designated or filed. If these other parameters provide additional validation to number of citing patents, then this may indicate that the patent/patent applications are strong patents and worth protecting.

Also, if there are a large number of cited patents/patent applications and/or a large number of literature citations then, because of the vast amounts of prior art, this might indicate that the patent/patent applications are weak. Each of these indicators is not enough to judge the value and/or strength of the patent content but, the information combined and with the patents grouped in a manner easy to view, provides a fast and easy way to know the value and strength of a single or many patents and where there is a high probability of finding valuable patents.

Therefore, the conclusions drawn by the user can be validated or strengthened by this additional information. It should be noted that the information is not limited to the parameters specified above. Any parameter that provides information on patents can be used.

Another feature that is available is the ability to categorize the citation information. For example, separate and group the number of self citations, patents that are citing other patents invented by the same inventor or assignee. Also, the number of citations referenced from other patents or patent groups to the patent or patent groups being evaluated, can be separated and grouped. Another feature includes separating the citing groups over time. This would enable the user to pick up the strongest group of patents over a time period. Separating data over time may be accomplished by having a data field linked to the access number or patent number or by importing one time period per column where any record in the column belongs to the same time period. Further, it is possible to separate the citations based on how they are applied to the patent/patent applications and their significance. For example, patents cited in Europe are labeled as “X” if they anticipate the patent or “Y” if the reference, in combination, provides grounds for an obvious type rejection over the patent. Therefore, these citations can be displayed, as separate groups or next to the totals in order to make a comparison. These above features gives the user the flexibility to break down the citation information into underlying categories to provide more defined information, if needed.

The exemplary screen display of FIG. 7 provides the user with a statistical view of all the cited patents and references in the patents from a selected group in FIG. 6. The first row 730 contains the number of patents that are citing other patents and references. The first column contains information pertaining to the number of patent applications in a patent family 725, the number of countries in the patent family 720 and the number of patents cited in the patent family 710. The patent family is the group of patents/patent applications belonging to the same invention. The numbers starting in the location at the intersection of the second column and third row, represent the number of patent families. For example, the number 1 referenced by 705, represents 1 patent family. Therefore, there are 10-19 patents/patent applications that are citing 1 patent family, which has 5-9 patents/patent applications in the family. Another example, referenced by 715, represents 3 patent families. Thus, 5-9 patents/patent applications are citing 3 patent families, in which the 3 patent families are citing 10-19 other patents/patent families.

Another feature of FIG. 6 and 7 is the ability to graph the data that is displayed. If the data in the first column, of FIG. 6, is clicked with a mouse or similar device, the user is prompted and can select to graph the row or the subclasses under the data selected. In FIG. 7, when the data is clicked, the data corresponding to the sections of data in the first column (i.e., patent applications, countries etc) will be graphed. The graphs can be manipulated to the users needs.

Added features that may be incorporated into the present invention are discussed below. One feature is that the present invention can be customized to work in project groups. This has it's greatest advantages when evaluating individual patents. When various individuals are viewing the same information, these various individuals can classify and give priorities to the patents. The results issued by these various individuals viewing the data can be gathered into a database grouped on own classifications where different columns represent the priorities of the patents and all these groups are linked to the underlying documents including the comments provided.

Another feature is the ability of the present invention to help find mergers and acquisitions. The ability to search any bibliographical database makes it possible to obtain data about mergers and acquisitions. The data can then be compared with other data based on the users desires. This provides a greater amount of information in determining the value of a patent or patent portfolio. For example, a search can be made in Gales PROMPT database at Dialog. A company name is searched for and the search result is limited by the event code for mergers and acquisitions. This data is imported into a column and grouped by company name. The data is then available to manipulate and view according to the users desires.

Another feature is the ability to display only different parts in a display which is based on trends, where the user can choose to limit the display by different criteria, for example the speed in growth of the number of patents/patent applications. Also, the import of patents which have expired, for any number of reasons, can be compared in a separate column with the rest of the patent information in the patent portfolio in order to find technology which is no longer supported and evaluate the effects they have in the citation statistics. Further, another feature is the ability to easily access any system (as selected access numbers) to retrieve information and also to make use of their analytical capabilities.

While this invention has been described in conjunction with the exemplary embodiments outlined above, it is evident that many alternatives, modifications and variations will be apparent to those skilled in the art. Accordingly, the exemplary embodiments of the invention may be made without departing from the spirit and scope of the invention.

What is claimed is:

1. A method for managing data, comprising the steps of:
establishing a link with a database;
importing bibliographic data from the database;
grouping the imported data into at least one category;
storing the bibliographic data in at least one internal database;
linking together the corresponding imported data to form a record;
selecting at least one category for viewing;
retrieving the records from the selected categories; and
displaying the records by the selected categories.

2. The method of claim 1, wherein the imported data is linked to corresponding imported data by a tight link.

3. The method of claim 2, wherein the tight link corresponds to an access number and/or a patent number.

4. The method of claim 3, wherein the selected data is displayed in a graphical format.

5. The method of claim 1, wherein the groupings of the data are chosen by the user.

6. The method of claim 1, wherein the groupings are listed in categories named by the user.

7. The method of claim 1, wherein data imported from at least one database provide information to each of the patents or documents cited for a particular patent or group of patents.

8. The method of claim 1, wherein each internal database stores a predetermined category of imported data.

9. The method of claim 1, wherein a parameter file is created, prior to importation of data, which contains various categories of bibliographic data for an individual record.

10. The method of claim 1, wherein the data is displayed in a spreadsheet format in accordance with a user's preference selection.

11. The method of claim 1, wherein the displayed data can be manipulated by a user in order to view the data most relevant to the user's needs.

12. The method of claim 1, wherein the bibliographic data pertains to patents.

13. A system for acquiring and presenting data, comprising:
a computer that establishes a link with a database and imports data from the database,
a memory that stores the imported data in various groupings and categories;
an internal parameter that links corresponding data with each other to form a record of data;
a selection component that allows a user to select particular data of a record and the format of the data for display; and
a presentation device that displays the selected data.

14. The system of claim 13, wherein the imported data is bibliographic data related to patents.

15. The system of claim 13, wherein the data is linked by the internal parameter according to access number and/or patent number.

16. The system of claim 13, wherein the data is provided in a statistical spreadsheet format.

17. The system of claim 13, wherein the data is presented in a graphical format.

18. The system of claim 13, wherein data may be marked by the user with an indication of priority.

19. The system of claim 13, wherein the data imported includes the number of references cited to a patent.

20. A computer readable medium containing a program which executes the following steps:
establishing a link with a database;
importing data from the database, where the data includes bibliographic data;
grouping the imported data into at least one category;
storing the grouped bibliographic data in at least one internal database;
linking corresponding imported data to form a record;
selecting at least one category for viewing;
retrieving the records from the selected categories; and
displaying the records by the selected categories.
